(19) United States
(12) Patent Application Publication
(10) Pub. No.: US 2025/0310176 A1
(43) Pub. Date: Oct. 2, 2025

(54) AUTO-TUNABLE PARAMETERIZED WINDOW-BASED ANOMALY DETECTION

(71) Applicant: Snowflake Inc., Bozeman, MT (US)

(72) Inventors: Sandeep Chandana, Fremont, CA (US); Tadeusz Jargilo, Ruda Slaska (PL); Aditya Kumar, Pune (IN); Ameya Mahesh Sanzgiri, Fremont, CA (US); Boyu Wang, Redwood City, CA (US)

(21) Appl. No.: 18/622,425

(22) Filed: Mar. 29, 2024

(51) Int. Cl. H04L 41/0604; H04L 41/16

(52) U.S. Cl. CPC H04L 41/0622; H04L 41/0627; H04L 41/16

(57) ABSTRACT

Disclosed is a method of detecting anomalies in time series data. The method includes computing a first bound for a first window of the time series a second bound for a second window of the time series, wherein the second window includes more samples of the time series data. The method also includes generating a first outlier status that indicates whether a current value of the time series data exceeds the first bound, and generating a second outlier status that indicates whether the current value of the time series data exceeds the second bound. The method also includes determining, by a processing device, whether an anomaly is detected in the time series data based on values of the first outlier status and the second outlier status. The method also includes generating an alert in response to determining that the anomaly is detected and sending the alert to a notification system.

### TECHNICAL FIELD

Aspects of the present disclosure relate to time series analysis, and more particularly, to techniques for detecting anomalies in time series data.

### BACKGROUND

Time-series analysis often refers to a variety of statistical modeling techniques including trend analysis, seasonality/cyclicality analysis, and anomaly detection. Predictions based on time-series analysis are extremely common and used across a variety of industries. For example, in computing systems, anomaly detection can be used to detect system failures, cyber attacks and intrusions, and other system abnormalities.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram of an example anomaly detection service in accordance with some embodiments of the present disclosure.

FIG. 3A is a graph illustrating the results of an example anomaly detection process in accordance with some embodiments of the present disclosure.

FIG. 3B is a graph illustrating the monitored metric corresponding to FIG. 3A in accordance with some embodiments of the present disclosure.

FIG. 4 is a block diagram of an example anomaly detection system in accordance with some embodiments of the present disclosure.

FIG. 5 is a process flow diagram of a method of performing anomaly detection, in accordance with some embodiments of the present disclosure.

FIG. 6 is a process flow diagram summarizing a method of performing anomaly detection, in accordance with some embodiments of the present disclosure.

FIG. 7 illustrates a diagrammatic representation of a machine in the example form of a computer system within which a set of instructions, for causing the machine to perform any one or more of the methodologies described herein.

### DETAILED DESCRIPTION

Anomaly detection is often performed to monitor performance and maintain reliable operation of computing systems, such as cloud computing systems and the like. Detecting an anomaly can help provide early identification of potential performance degradations or system failures. Anomaly detection can be applied to various types of time series data related to computing metrics. One technique for detecting anomalies in time series data is to provide an upper and lower bound for the monitored metric and generate an alert any time that the metric falls outside of these bounds. In a distributed data architecture, the upper and lower bounds may be determined based on a data contract established between a provider and a consumer that defines the rules of exchange between the parties. This technique can be effective when the monitored metric is relatively stable over time. However, if there is an increasing or decreasing trend over time, this anomaly detection method may tend to generate false positive anomaly detections, at which the data contract may have to be updated.

In some cases, time series forecasting may be used to improve the accuracy of anomaly detection. For example, a forecast for a time series may be used to automatically adjust the upper and lower bounds to be better suited for future expectations. However, obtaining accurate forecasting is challenging and many of the algorithms currently being used for time series forecasting have considerable drawbacks. For example, many algorithms can only fit a linear trend or only one seasonal component, which is an invalid assumption in most use cases. Other algorithms are slow to train and can consume a lot of memory, while also lacking features such as support for multiple seasonal components and holiday effects. In addition, many algorithms suffer from relatively low accuracy.

Embodiments of the present disclosure provide a robust, adaptable method to automatically detect the anomalies in a time series dataset. The techniques described herein may be used to detect analyze metrics related to relational databases such as the amount of data ingested in the tables, sparsity of tables, number of nulls in specific columns over a period of time, and others. However, it will be appreciated that the disclosed techniques can be applied to different types of data and systems.

According to embodiments of the present techniques, time series data is separated into multiple separate time windows of varying duration. The historical data within each time window may be used to compute an upper and/or lower bound applicable for that time window. Outlier detection is then performed separately for each window on a continuous stream of data. For a specific time window, if the monitored metric falls outside the upper and lower bounds computed for that time window, an outlier detection may be reported for that specific time window. As used herein, the term “outlier status” refers to the result of this comparison, which indicates whether the current value of time series data exceeds the upper and lower bounds. The outlier status reported for each time window may be combined to determine whether an actual anomaly is detected. For example, a voting scheme may be used to generate an alert if an outlier is reported for a majority of the time windows, i.e., the outlier status is positive for the majority of time windows. In some embodiments, an alert can be generated if the outlier status is positive for any one of the windows. Other schemes are also possible.

Alerts generated by the technique described above may be sent to a notification module, which is used to inform users about possible abnormalities identified in the data. In some embodiments, a feedback component can be used to adjust the anomaly detection parameters so that the anomaly detection process become more accurate over time. The present technique also enables users to customize the anomaly detection parameters to a particular system or dataset, which gives the user finer control over the amount of alerts generated in the system. This approach proves to be very effective in scenarios where existing methods to detect anomalies don't perform very well. For example, the method described herein is able to quickly adapt to changing trends in the data without the need to predict future trends using a time series forecasting technique. In some embodiments, the multiple-window technique described herein may be combined with other anomaly detection techniques such as Bollinger bands, time series forecasting and others.

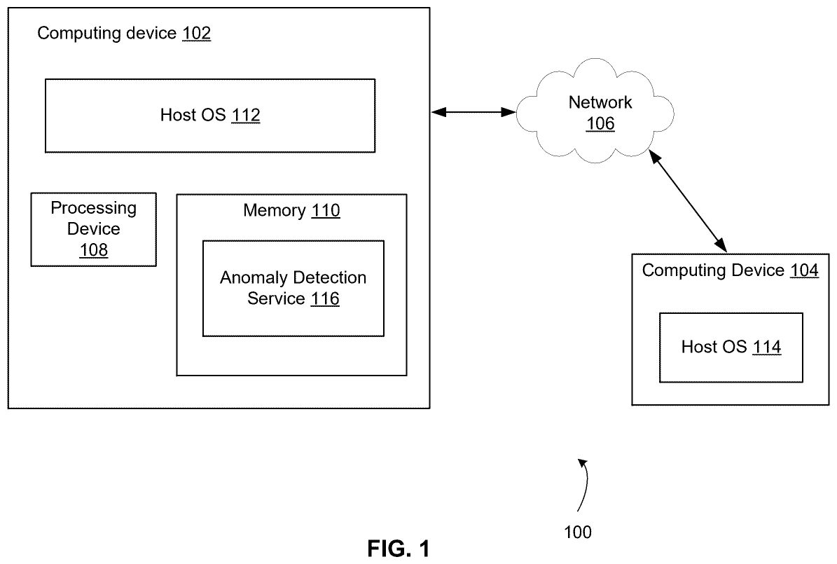

FIG. 1 is a block diagram that illustrates an example system 100 in accordance with some embodiments of the present disclosure. As illustrated in FIG. 1, the system 100 includes a computing device 102 and a computing device 104. The computing devices 102 and 104 may be coupled to each other (e.g., may be operatively coupled, communicatively coupled, may communicate data/messages with each other) via network 106. The network 106 may be a public network (e.g., the internet), a private network (e.g., a local area network (LAN) or wide area network (WAN)), or a combination thereof. In one embodiment, network 106 may include a wired or a wireless infrastructure, which may be provided by one or more wireless communications systems, such as a WiFi™ hotspot connected with the network 106 and/or a wireless carrier system that can be implemented using various data processing equipment, communication towers (e.g., cell towers), etc. In some embodiments, the network 106 may be an L3 network. The network 106 may carry communications (e.g., data, message, packets, frames, etc.) between computing device 104 and computing device 104.

Each computing device 102 and 104 may include hardware such as processing device 108 (e.g., processors, central processing units (CPUs)), memory 110 (e.g., random access memory (e.g., RAM)), storage devices (e.g., hard-disk drive (HDD), solid-state drive (SSD), etc.), and other hardware devices (e.g., sound card, video card, etc.). In some embodiments, memory 110 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 110 may be configured for long-term storage of data and may retain data between power on/off cycles of the computing device 102.

Each computing device 102 and 104 may comprise any suitable type of computing device or machine that has a programmable processor including, for example, server computers, desktop computers, laptop computers, tablet computers, smartphones, etc. In some examples, each of the computing devices 102 and 104 may comprise a single machine or may include multiple interconnected machines (e.g., multiple servers configured in a cluster). The computing devices 102 and 104 may be implemented by a common entity/organization or may be implemented by different entities/organizations. For example, computing device 102 may be operated by a first company/corporation and computing device 104 may be operated by a second company/corporation.

Each computing device 102 104 may include an operating system (OS) such as host OS 112 and host OS 114, respectively. The host OS of a computing device 102 and 104 may manage the execution of other components (e.g., software, applications, etc.) and/or may manage access to the hardware (e.g., processors, memory, storage devices etc.) of the computing device. In some embodiments, each of computing device 102 and computing device 104 may constitute a deployment of a cloud data platform or data exchange.

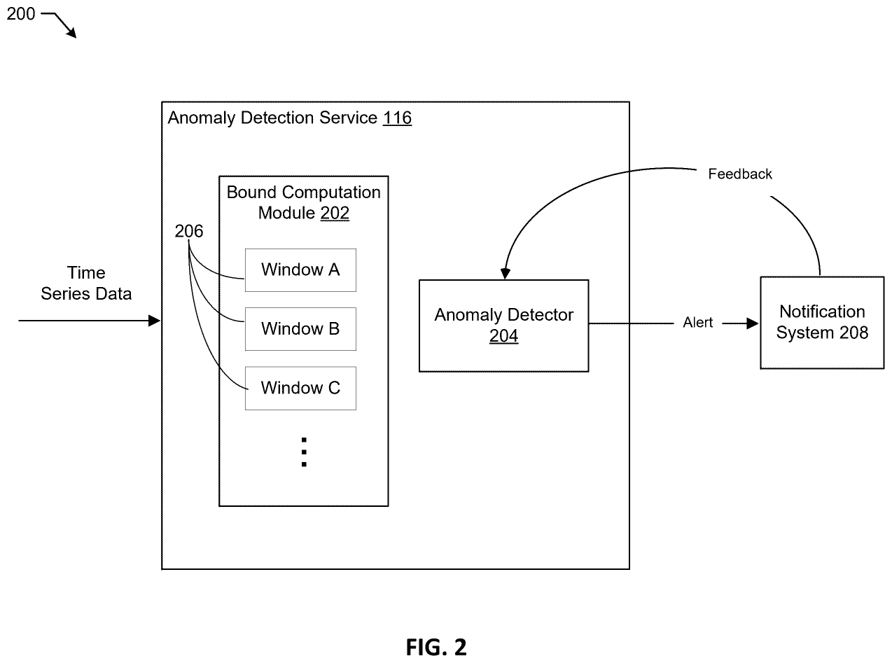

As shown in FIG. 1, the memory 110 of computing device 102 includes an anomaly detection service 116, which may be executed by the processing device 108 in order to perform some or all of the functions described herein. As described further below in relation to FIG. 2, anomaly detection service 116 may be configured to detect anomalies in a continuous stream of data, referred to herein as time series data. The time series data may describe the value of a metric at discrete intervals of time. In some embodiments, the metric may relate to the performance of a computing system such as a cloud data platform, cloud data exchange, database server, and others. For example, the metric may be a volume of data ingested into a table, the sparsity of a table, the number of nulls in a specific column of a table, and others. The time interval may be any suitable number of days, hours, minutes, or seconds, for example.

The anomaly detection service 116 may be configured to implement a parameterized model for detecting anomalies. The user (e.g., system administrator) may be able to adjust some or all of the various parameters to customize the anomaly detection model to better suit the user's needs. The anomalies detected by the anomaly detection service 116 may be logged and/or used to trigger an alert that may be sent for example, to a system administrator.

FIG. 2 is a block diagram of an example anomaly detection service 116 in accordance with some embodiments of the present disclosure. The anomaly detection service 116 shown in FIG. 2 includes a bound computation module 202 and an anomaly detector 204. The bound computation module 202 computes the anomaly detection bounds (e.g., upper bounds and lower bounds) applicable for each one of a set of time series windows 206, which are shown in FIG. 2 as window A, window B, and window C. However, it will be appreciated that any number of windows 206 may be used, including two windows, four windows, or more. In some embodiments, the number of windows may be a tunable parameter that may be specified by a system administrator and/or adjusted automatically.

Each window 206 may be associated with a different sample window that determines the amount of historical data used to compute the anomaly detection bounds. For example, window A may cover 3 days of data samples, window B may cover 7 days of data samples, and window C may cover 14 days of data samples. However, it will be appreciated that a combination of window sizes may be used and that the window sizes may be expressed in any suitable unit, including an amount of time, a number of samples, etc.

In some embodiments, the anomaly detection bounds for a particular window are determined by computing a rolling average of the metric value over the sample window. This rolling average may be referred as the sample mean. The anomaly detection bounds may then be computed based on the distribution of the residuals, wherein the term residual refers to the difference between a particular sample and the sample mean. In some embodiments, the following equation may be used to compute the rolling average at time t.

$$\overline{Q} ( t ) = \frac{1}{k} {\sum }_{j = 1}^{k} {Q}^{t - j}$$

In the above equation, Q^{t} is the value of the monitored metric at time t, Q̅(t) represents the mean of the sample window at time t, and k represents the number of samples of historical data to be used to compute the mean.

The residual values may then be computed as the difference between each sample and the sample mean at time, Q̅(t). The residuals may also be normalized using any suitable normalization scheme, including percent difference, z-score, and others. For example, if percent difference normalization is used, the residuals may be computed according to the following equation:

$$\tilde{Q} ( t ) = \frac{{Q}^{t} - \overline{Q} ( t )}{\overline{Q} ( t )}$$

If z-score normalization is used, the residuals may be computed according to the following equation, where σ (Q^{t-1}, . . . , Q^{t-k}) is a function that calculates the standard deviation of Qⁿ over the sample window:

$$\tilde{Q} ( t ) = \frac{{Q}^{t} - \overline{Q} ( t )}{σ ( {Q}^{t - 1} , … , {Q}^{t - k} )}$$

In the above equations, \tilde{Q}(t) represents the residual for the sample at time t. Accordingly, the residual distribution may be represented as the accumulated residuals computed for each time step in the sample window, i.e., \tilde{Q}(t), \tilde{Q}(t-1), . . . .\tilde{Q} (t-k). The upper and lower bounds may be computed based on this residual distribution for the sample window. For example, the upper bound may be set to a value that is multiple standard deviations greater than the mean residual value, the 95th percentile residual value, and others. The lower bound may be computed in a similar manner. The upper bound and the lower bound may also be unnormalized. The above process is repeated to generate upper and lower bounds for each window 206.

The upper bound and/or lower bound computed for each window 206 may be provided to the anomaly detector. If the value of the monitored metric, Qt, exceeds the upper bound or falls below the lower bound for any window 206, the anomaly detector 204 may record an outlier for that corresponding window. The anomaly detector 204 then determined whether an anomaly has been detected based on the combination of outliers recorded for each of the windows. For example, an anomaly may be triggered if outliers are recorded for any one window, two or more windows, a majority of the windows, and other combinations. In some embodiments, an anomaly is triggered based on a weighted average of the recorded outliers, where each window is associated with a corresponding weight. Various other voting schemes may be implemented.

If the anomaly detector 204 determines that an anomaly has been detected, the anomaly detector 204 may trigger an alert, which is sent to a notification system 208. The notification may be accessed through a network, such as the network 106. In some examples, the notification system 208 may include a graphical user interface (GUI) that enables a user to receive the alert and review any data related to the alert, such as the underlying time series data.

If the user determines through inspection of the data that the alert does not indicate a true problem, the user may identify the alert as a false positive anomaly detection, which may be provided as feedback to the anomaly detector 204. The anomaly detector 204 can use this feedback to adjust one or more parameters to refine the anomaly detection parameters and thereby reduce the number of false positives in the future. For example, the feedback may be used to adjust the upper and/or lower bounds of one or more windows 206 to expand the bounds (i.e., increase the upper bound and/or decrease the lower bound). In some embodiments, the equation for computing the bounds may include an adjustment parameter that is added to or factored into the computation. For example, if an anomaly is detected due to the metric exceeding the upper bound for window A, and the feedback indicates a false positive, the upper bound for window A may be increased by increasing the adjustment factor. In this way, subsequent computations of the upper bound will result in a higher value, which reduces the probability that the metric will trigger an outlier detection. This technique may also be employed for the lower bounds and any of the other windows 206. Other tunable parameters of the anomaly detection scheme include the number of windows, the size of the windows, the weight corresponding to each window (if a weighted average is used to trigger anomalies), and others.

In some embodiments, the anomaly detection process can be refined in the absence of specific feedback. For example, the bounds can be restricted (i.e., decrease the upper bound and/or increase the lower bound) if no outliers are detected within a specified period of time, e.g., hourly, daily, several days, etc. The bounds can be restricted for windows 206 individually using the same adjustment parameters described above. In this way, the upper and lower bounds can be refined over time to be more sensitive to actual anomalies, resulting in fewer false negatives.

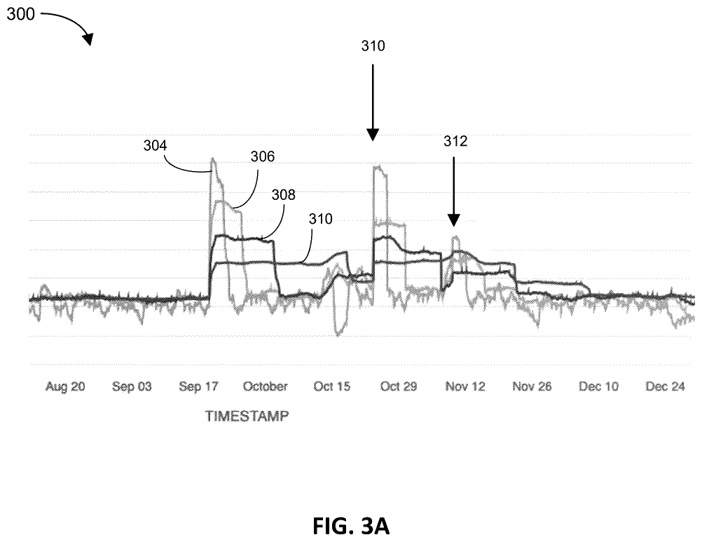

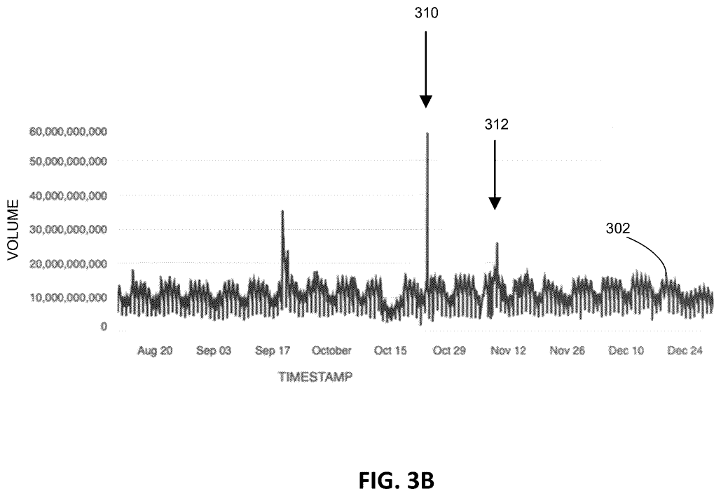

FIG. 3A is a graph illustrating the results of an example anomaly detection process in accordance with some embodiments of the present disclosure. The graph 300 of FIG. 3A demonstrates the effect of the rolling standard deviations computed for different window sizes. For context, FIG. 3B shows the monitored metric. In this example, the monitored metric (i.e., the time series data 302 of FIG. 3B) is daily table volume, which is shown on the Y-axis and refers to the number of rows of data added to a table over time. In FIGS. 3A and 3B, the X-axis represents time measured in days. For the sake of clarity, only the upper bounds are shown in FIG. 3A. However, it will be appreciated that the process may also involve the application of a lower bound.

As shown in FIG. 3A, there are four lines representing the upper bounds computed for four different time windows, a first upper bound 304, a second upper bound 306, third upper bound 308, and a fourth upper bound 310. In this example, the first upper bound 304 has a window size of 3 days, the second upper bound 306 has a window size of 7 days, the third upper bound 308 has a window size of 14 days, and the fourth upper bound has a window size of 30 days. Each of the upper bounds are computed using a rolling window of the time series data 302, which is updated at each time step, which is every day in this example. In this graph 300, it can be seen that the smaller time window of the first upper bound 304 is more responsive to changes in the time series data 302 as shown by the fact that the first upper bound 304 rises higher and falls more quickly after the first large spike in the time series data 302. By contrast, the third upper bound 308 does not rise as high, but stays high for longer due to the continued effect of that spike within the larger time window.

Also shown in the FIGS. 3A and 3B are several potential anomalies, including potential anomalies 310 and 312. At the first potential anomaly 310, the time series data 302 exceeds all four of the upper bounds 304, 306, 308, and 310. Accordingly, an outlier will be recorded for all four time windows. In this case, the anomaly detector 204 will report an anomaly and send an alert as described in relation to FIG. 2. At the second potential anomaly 312, the time series data 302 exceeds the first upper bound 304, but not the second, third, or fourth upper bounds 306, 308, and 310. Accordingly, an outlier will be recorded only for the first time window.

Depending on the voting scheme or weighting method used, this potential anomaly could also be reported as an anomaly and trigger an alert. However, in some embodiments, the anomaly detector 204 may not report an anomaly or send an alert if an outlier is detected for only one of the time windows.

The graph 300 of FIG. 3A demonstrates that the bounds are dynamically updated at each time step. This enables the anomaly detection to quickly adapt to changes in the time series data while also being able to detect deviations that are significant enough to indicate an anomaly. Accordingly, the disclosed anomaly detection technique is able to respond to variations in the time series data without time series forecasting.

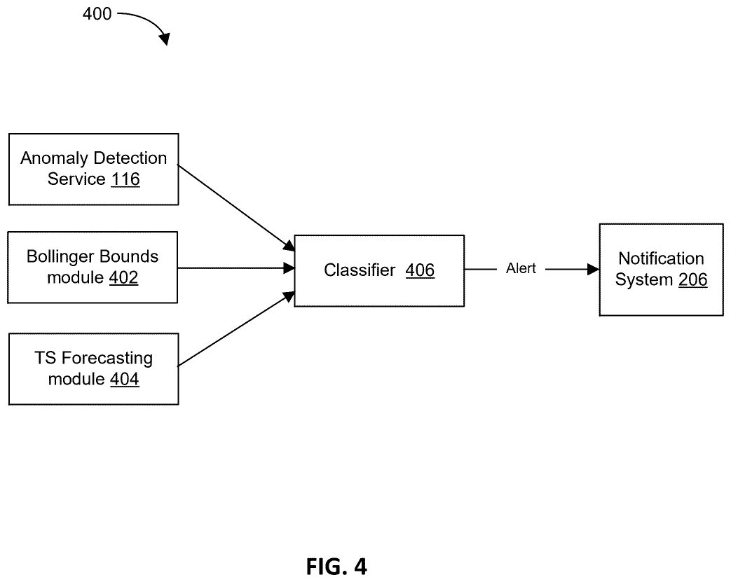

FIG. 4 is a block diagram of an example anomaly detection system 400 in accordance with some embodiments of the present disclosure. The anomaly detection system 400 includes the anomaly detection service 116 as described in relation to FIGS. 1-3. However, in this embodiment, the output of the anomaly detection service 116 is combined with other anomaly detection techniques, such as Bollinger bounds, and time series forecasting. Accordingly, the anomaly detection system 400 includes a Bollinger bounds module 402, and a time series forecasting module 404, both of which may be implemented as processing logic in the computing device 102 as shown in FIGS. 1

The Bollinger bounds module 402 may perform a statistical analysis to detect sharp, short-term deviations in the time series data. The time series forecasting module 404 can be used to predict future trends in the time series data so that the upper and lower bounds used to detect anomalies can be adjusted accordingly. The anomaly detection service 116, Bollinger bounds module 402, and the time series forecasting module 404 can each perform separate anomaly detections in accordance with their own programming and provide their respective outputs to a classifier 406. The classifier 406 processes these potential anomaly detections to determine whether to generate an alert. For example, the classifier may use a voting scheme, compare a weighted average of the inputs to a threshold, and other techniques. In some embodiments, the classifier may be a machine learning algorithm.

Any alerts generated may be sent to the notification system as described in relation to FIG. 2. Additionally, although not shown, the notification system 208 may be configured to send feedback to the anomaly detection service 116 as described above in relation to FIG. 2.

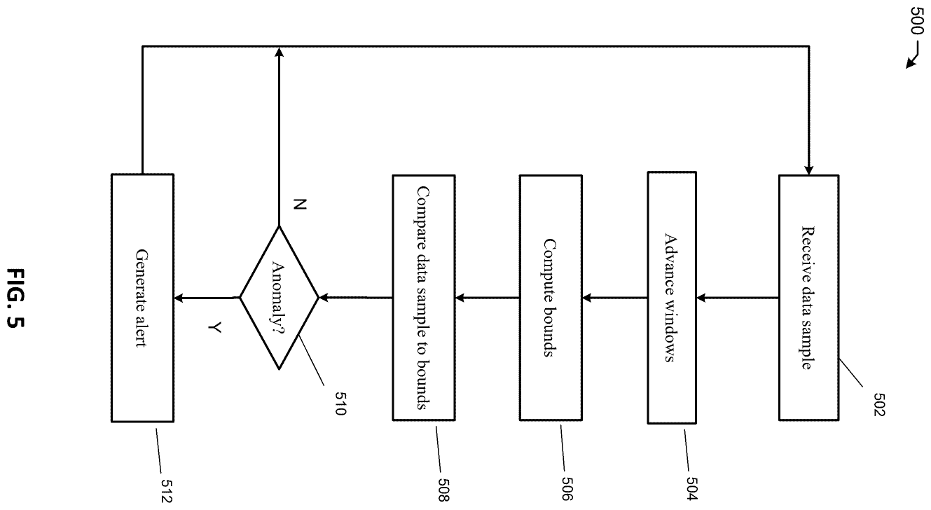

FIG. 5 is a process flow diagram of a method 500 of performing anomaly detection, in accordance with some embodiments of the present disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by a computing device (e.g., computing device 102 executing the anomaly detection service 116 as shown in FIGS. 1 and 2). The method 500 may be performed to detect anomalies in a continuous stream of data (i.e., time series data), beginning at block 502.

At block 502, a data sample is received. The data sample is the latest data sample to be received for the monitored metric and added to the time series dataset. For the sake of the present description, it is assumed that previous data samples have been collected so that historical time series data has been stored for each window.

At block 504, the windows are advanced. Each window is a rolling window with a specified fixed length and covers a span of time (or number of data samples) that includes the current time step (e.g., the current data sample). Thus, advancing the window may mean adding the new data sample to an array, shifting each data sample down one position, and removing the oldest data sample. Each window is configured to cover a different amount of time and will therefore have a different number of previous (i.e., historical) data samples. For example, a first window may have N samples, a second window may have 2N samples, and a third window may have 4N samples.

At block 506, bounds are computed for the windows. The bound for each window may be computed by computing a mean value of the samples in that window and determining a distribution of the residuals in that window. Additional details for computing the bounds are provided in relation to FIG. 2. The bound computed for each window may be an upper bound or lower bound. In some embodiments, both an upper and lower bound are computed.

At block 508, the current data sample received at block 502 is compared to the various bounds to determine whether an anomaly is detected. Based on comparison, an outlier status is determined for each window based on whether the value exceeds the bounds computed for the specific window. The outlier status (e.g., positive or negative) for all of the windows is used to determine whether an anomaly is detected.

At block 510, a decision is made regarding whether an anomaly was detected at block 508. If an anomaly is detected, the process flow advances to block 512 and an alert is generated. The alert may be stored to a log and/or sent through a communications network to a user such as a system administrator or owner of the data. After generating the alert or if no anomaly is detected, the process flow returns to block 502 and a new data sample is received.

It will be appreciated that embodiments of the method 500 may include additional blocks not shown in FIG. 5 and that some of the blocks shown in FIG. 5 may be omitted. Additionally, the processes associated with blocks 502 through 512 may be performed in a different order than what is shown in FIG. 5.

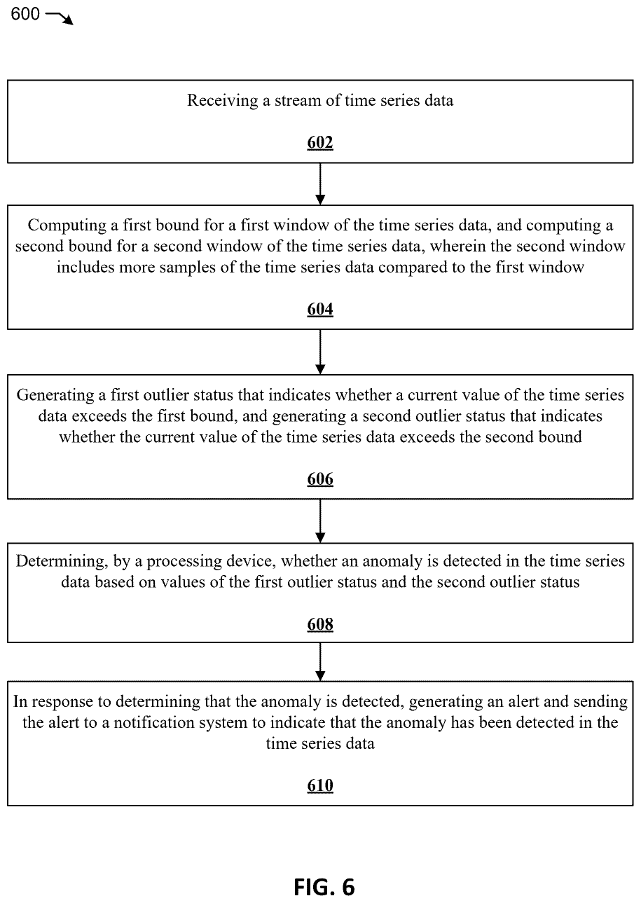

FIG. 6 is a process flow diagram summarizing a method 600 of performing anomaly detection, in accordance with some embodiments of the present disclosure. Method 600 may be performed by processing logic that may comprise hardware, software, firmware, or a combination thereof. For example, the method 600 may be performed by a computing device such as the computing device 102 executing the anomaly detection service 116 as shown in FIGS. 1 and 2. The method may begin at block 602.

At block 602, a stream of time series data is received. The time series data may include values for any suitable metric, including daily table volume and others. The time step may be any suitable time span, e.g., one minute, ten minutes, one hour, one day, one week, etc.,

At block 604, a first bound is computed for a first window of the time series data, and a second bound is computed for a second window of the time series data. The second window includes more samples of the time series data compared to the first window. Additional bounds may also be computed. For example, if first bound is an upper bound, a lower bound may also be computed. Additional bounds, (upper, lower, or both) may be computed for additional windows, each window covering a different time span and having a different number of samples.

At block 606, a first outlier status that indicates whether a current value of the time series data exceeds the first bound is generated, and a second outlier status that indicates whether the current value of the time series data exceeds the second bound generating. Exceeds in this context means that the current value is higher than an upper bound or lower than a lower bound. An outlier status may be determined for each window.

At block 608, a processing device determines whether an anomaly is detected in the time series data based on values of the first outlier status and the second outlier status. Detecting an anomaly may also be based on one or more additional outlier statuses computed for the other windows. For example, a voting scheme may be implemented using the outlier status for each window, as described above.

At block 610, in response to determining that the anomaly is detected, generating an alert and sending the alert to a notification system to indicate that the anomaly has been detected in the time series data.

It will be appreciated that embodiments of the method 600 may include additional blocks not shown in FIG. 6 and that some of the blocks shown in FIG. 6 may be omitted. Additionally, the processes associated with blocks 602 through 610 may be performed in a different order than what is shown in FIG. 6.

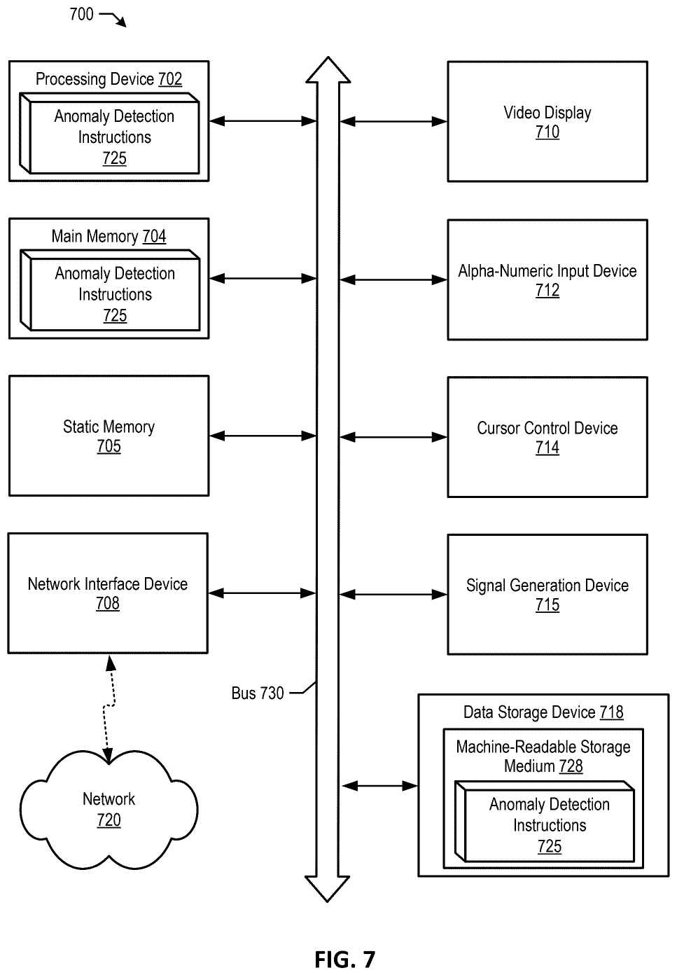

FIG. 7 illustrates a diagrammatic representation of a machine in the example form of a computer system 700 within which a set of instructions, for causing the machine to perform any one or more of the methodologies described herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server.

The exemplary computer system 700 includes a processing device 702, a main memory 704 (e.g., read-only memory (ROM), flash memory, dynamic random access memory (DRAM)), a static memory 705 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 700 may further include a network interface device 707 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 715 (e.g., a speaker). In one embodiment, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute anomaly detection instructions 725, for performing the operations and steps discussed herein.

The data storage device 718 may include a machine-readable storage medium 728, on which is stored one or more sets of anomaly detection instructions 725 (e.g., software) embodying any one or more of the methodologies of functions described herein. The anomaly detection instructions 725 may also reside, completely or at least partially, within the main memory 704 or within the processing device 702 during execution thereof by the computer system 700; the main memory 704 and the processing device 702 also constituting machine-readable storage media. The anomaly detection instructions 725 may further be transmitted or received over a network 720 via the network interface device 707.

While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “sending,” “routing,” “updating,” “providing,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a stream of time series data;
computing a first bound for a first window of the time series data, and computing a second bound for a second window of the time series data, wherein the second window includes more samples of the time series data compared to the first window;
generating a first outlier status that indicates whether a current value of the time series data exceeds the first bound, and generating a second outlier status that indicates whether the current value of the time series data exceeds the second bound;
determining, by a processing device, whether an anomaly is detected in the time series data based on values of the first outlier status and the second outlier status; and
in response to determining that the anomaly is detected, generating an alert and sending the alert to a notification system to indicate that the anomaly has been detected in the time series data.

2. The method of claim 1, wherein the first bound and the second bounds are upper bounds, and wherein the method further comprises:
computing a first lower bound for the first window of the time series data, and computing a second lower bound for the second window of the time series data.

3. The method of claim 1, wherein the method further comprises:
computing a third bound for a third window of the time series data, wherein the third window includes more samples of the time series data compared to the second window; and
generating a third outlier status that indicates whether the current value of the time series data exceeds the third bound;
wherein generating the alert is further based on a value of the third outlier status.

4. The method of claim 3, wherein generating the alert comprises:
computing a weighted average of the first outlier status, the second outlier status, and the third outlier status; and
comparing the weighted average to a threshold.

5. The method of claim 3, wherein generating the alert comprises applying a voting scheme to the first outlier status, the second outlier status, and the third outlier status.

6. The method of claim 1, wherein computing the first bound comprises:
computing a mean value of samples in the first window; and
computing a distribution of residuals corresponding to each sample in the first window;
wherein the first bound is computed based on the distribution of the residuals.

7. The method of claim 1, further comprising:
receiving feedback from the notification system indicating that the alert is a false positive anomaly detection; and
in response to the feedback, increasing an adjustment factor applied to the first bound for subsequent computations of the first bound.

8. A system comprising:
a memory; and
a processing device, operatively coupled to the memory, the processing device to:
receive a stream of time series data;
compute a first bound for a first window of the time series data, and compute a second bound for a second window of the time series data, wherein the second window includes more samples of the time series data compared to the first window;
generate a first outlier status that indicates whether a current value of the time series data exceeds the first bound, and generate a second outlier status that indicates whether the current value of the time series data exceeds the second bound;
determine whether an anomaly is detected in the time series data based on values of the first outlier status and the second outlier status; and
in response to the anomaly being detected, generate an alert and send the alert to a notification system to indicate that the anomaly has been detected in the time series data.

9. The system of claim 8, wherein the first bound and the second bounds are upper bounds, and wherein the processing device is further to:
compute a first lower bound for the first window of the time series data, and compute a second lower bound for the second window of the time series data.

10. The system of claim 8, wherein the processing device is further to:
compute a third bound for a third window of the time series data, wherein the third window includes more samples of the time series data compared to the second window; and
generate a third outlier status that indicates whether the current value of the time series data exceeds the third bound;
wherein the processing device generates the alert based further on a value of the third outlier status.

11. The system of claim 10, wherein to generate the alert the processing device is to:
compute a weighted average of the first outlier status, the second outlier status, and the third outlier status; and
compare the weighted average to a threshold.

12. The system of claim 10, wherein to generate the alert the processing device is to apply a voting scheme to the first outlier status, the second outlier status, and the third outlier status.

13. The system of claim 8, wherein to compute the first bound the processing device is to:
compute a mean value of samples in the first window; and
compute a distribution of residuals corresponding to each sample in the first window;
wherein the first bound is computed based on the distribution of the residuals.

14. The system of claim 8, wherein the processing device is further to:
receive feedback from the notification system indicating that the alert is a false positive anomaly detection; and
in response to the feedback, increase an adjustment factor applied to the first bound for subsequent computations of the first bound.

15. A non-transitory computer-readable medium comprising instructions stored thereon which, when executed by a processing device, cause the processing device to:
receive a stream of time series data;
compute a first bound for a first window of the time series data, and compute a second bound for a second window of the time series data, wherein the second window includes more samples of the time series data compared to the first window;
generate a first outlier status that indicates whether a current value of the time series data exceeds the first bound, and generate a second outlier status that indicates whether the current value of the time series data exceeds the second bound;
determine, by the processing device, whether an anomaly is detected in the time series data based on values of the first outlier status and the second outlier status; and
in response to the anomaly being detected, generate an alert and send the alert to a notification system to indicate that the anomaly has been detected in the time series data.

16. The non-transitory computer-readable medium of claim 15, wherein the first bound and the second bounds are upper bounds, and wherein the instructions further cause the processing device to:
compute a first lower bound for the first window of the time series data, and compute a second lower bound for the second window of the time series data.

17. The non-transitory computer-readable medium of claim 15, further comprising instructions to cause the processing device to:
compute a third bound for a third window of the time series data, wherein the third window includes more samples of the time series data compared to the second window; and
generate a third outlier status that indicates whether the current value of the time series data exceeds the third bound;
wherein the processing device generates the alert based further on a value of the third outlier status.

18. The non-transitory computer-readable medium of claim 17, wherein to generate the alert comprises to:
compute a weighted average of the first outlier status, the second outlier status, and the third outlier status; and
compare the weighted average to a threshold.

19. The non-transitory computer-readable medium of claim 17, wherein to generate the alert comprises to apply a voting scheme to the first outlier status, the second outlier status, and the third outlier status.

20. The non-transitory computer-readable medium of claim 15, wherein to compute the first bound comprises to:
compute a mean value of samples in the first window; and
compute a distribution of residuals corresponding to each sample in the first window;
wherein the first bound is computed based on the distribution of the residuals.
